(19) United States
(12) Patent Application Publication
(10) Pub. No.: US 2018/0277086 A1
(43) Pub. Date: Sep. 27, 2018

(54) METHOD AND APPARATUS FOR USING MOBILE PHONE IN SECURITY RESTRICTED AREAS

(71) Applicant: High Sec Labs LTD., Yokneam industrial zone (IL)

(72) Inventor: Aviv SOFFER, Caesarea (IL)

(21) Appl. No.: 15/467,083

(22) Filed: Mar. 23, 2017

(51) Int. Cl. G10K 11/00; G10K 11/175

(52) U.S. Cl. CPC G10K 11/002; G10K 11/175

(57) ABSTRACT

An Active Quiet Box (AQB) for securing a mobile phone against eavesdropping is having an acoustically isolated, sealable chamber for placing the user's mobile phone, and at least one noise generator to saturate the user's mobile-phone with loud ambient noise. A power source provides power to the apparatus and charges the user's mobile-phone while it is in the sealed chamber.

### FIELD OF THE SUBJECT MATTER

The present subject matter relates to a method and apparatus that allows non-secure mobile phones to be used in secure environments. More specifically the present subject matter relates to a quiet box used to store mobile phones while blocking their camera view, actively preventing their microphones from picking up ambient sounds and allowing looking at incoming calls and messages.

### BACKGROUND

With the rapidly growing number of people using mobile phones, many work environments are struggling to keep confidential information protected in such environments. The presence of privately owned mobile phones in secure work environments is very challenging as phones can be hacked and controlled remotely by malicious code. Most people depend on the mobile phone to communicate with their family members, friends and colleges. In the past, many organizations enforced a policy that their employees would not be able to bring their mobile phones to work. In many cases employees had safe-boxes to store their mobile phones at specially assigned lockers located at the classified work environment gate. As mobile phones are extremely vulnerable to hacking that enables remote access to their cameras and microphones, the presence of these devices in secure areas is a significant security threat. Hacked mobile phones may be abused to listen to classified conversations remotely. Additionally, privacy and/or may be compromised by intentional or unintentional activation of recording application of the mobile phone by the user. Such covert recording may be inappropriately used or abused or leak into hostile hands.

Still the high dependence of employees in mobile phones, requires some secure way to keep them operating around the employee throughout the working day.

While mobile phone cameras can easily be blocked by non-transparent tape, microphones cannot be easily blocked. Mobile phone microphones are extremely sensitive and in many cases connected to high-quality amplifiers and signal processors that designed to filter and enhance the speech voices. In many phones there are more than one microphone elements to improve ambient noise immunity.

There are products in the market that completely disable the ability of mobile phones to communicate. These products are using Faraday's cage to block signal reception. This method does not allow users to receive calls or messages and therefore it is not desirable. Faraday type box for mobile phones can be obtained for example from the website www.digitaltrends.com/home/pause-container-blocks-cell-phone-signals.

### SUMMARY

What is needed is an apparatus that securely blocks audio eavesdropping while still allowing calls and messages reception visual indications. Preferably such apparatus should also enable mobile phone charging.

According to a first aspect of the present disclosed subject matter an Active Quiet Box (AQB) apparatus is provided, the AQB comprising:

an acoustically isolated, sealable chamber having:

a support for placing a user's mobile phone inside the sealable chamber; and

at least one noise generator to saturate the user's mobile-phone with loud ambient noise; and

a power source to power the apparatus and to provide power to charge the user's mobile-phone.

In some exemplary embodiments the sealable chamber further comprises at least one sensor to detect when the chamber is sealed.

In some exemplary embodiments the power to the user's mobile phone charging is enabled when the at least one sensor to is sensing that the sealable chamber is sealed.

In some exemplary embodiments the at least one sensor to detect when the chamber is sealed is air pressure sensor.

In some exemplary embodiments the sealed chamber is having transparent components to allow user to see the display of the user's mobile-phone while the sealable chamber is sealed.

In some exemplary embodiments the AQB apparatus further comprising a non-transparent element positioned in front of the mobile-phone camera of the user's mobile-phone to block its field of view.

In some exemplary embodiments the non-transparent element is a movable shutter, wherein the movable shutter is normally positioned in front of the mobile-phone camera of the user's mobile-phone to block its field of view; and the movable shutter is coupled to an actuator for moving the movable shutter to allow video call while the user's mobile-phone is within the AQB apparatus.

In some exemplary embodiments the AQB apparatus further comprising:

an audio connector for connecting a wired headset to allows voice phone call while the user's mobile-phone is within the AQB apparatus;

a switch, normally isolating the audio connector from the user's mobile-phone, and coupling the audio connector to the user's mobile-phone during voice phone call;

a timer, activating the switch to couple the id audio connector to the user's mobile-phone for a preset time; and

a push button for activating the timer.

In some exemplary embodiments the at least one noise generator is having at least two speakers to enable noise emission in random variable phase differences.

In some exemplary embodiments the noise generator is generating audio noise selectable from the list of: white noise, pink noise, random speech, multiple overlapping speech, bubbles noise and crowd noise.

In some exemplary embodiments the power source powering the AQB is a wall-mounted AC/DC power supply.

In some exemplary embodiments the power source is a vehicle DC power adaptor.

In some exemplary embodiments the power to the apparatus is provided by internal battery at times that other power source is unavailable.

In some exemplary embodiments the AQB apparatus further comprising user indicator to indicate apparatus secure and non-secure states.

In some exemplary embodiments a visual and/or aural indications are provided when the apparatus is powered by the battery or when battery is close to empty state.

According to a second aspect of the present disclosed subject matter a method for securing a user's mobile-phone is provided, the method comprising:

placing a user's mobile-phone within an acoustically isolated, sealable chamber; sealing the sealable chamber;

generating noise within the sealable chamber to saturate the user's mobile-phone with loud ambient noise; and

charging the user's mobile-phone within the sealable chamber.

In some exemplary embodiments the method for securing a user's mobile-phone further comprising:

sensing when the sealable chamber is sealed; and

generating noise within the sealable chamber only while aid sealable chamber is sealed.

In some exemplary embodiments charging the user's mobile-phone is enabled only when the sealable chamber is sealed.

In some exemplary embodiments sensing when the sealable chamber comprises sensing air pressure increase when the sealable chamber is being sealed.

In some exemplary embodiments the method for securing a user's mobile-phone further comprising indicating secure and non-secure states.

Unless otherwise defined, all technical and scientific terms used herein have the same meaning as commonly understood by one of ordinary skill in the art to which this subject matter belongs. Although methods and materials similar or equivalent to those described herein can be used in the practice or testing of the present subject matter, suitable methods and materials are described below. In case of conflict, the patent specification, including definitions, will control. In addition, the materials, methods, and examples are illustrative only and not intended to be limiting.

Unless marked as background or art, any information disclosed herein may be viewed as being part of the current subject matter or its embodiments.

### BRIEF DESCRIPTION OF THE OF THE DRAWINGS

Some embodiments are herein described, by way of example only, with reference to the accompanying drawings. With specific reference now to the drawings in detail, it is stressed that the particulars shown are by way of example and for purposes of illustrative discussion of the preferred embodiments only, and are presented in the cause of providing what is believed to be the most useful and readily understood description of the principles and conceptual aspects of the subject matter. In this regard, no attempt is made to show structural details in more detail than is necessary for a fundamental understanding of the subject matter, the description taken with the drawings making apparent to those skilled in the art how the several forms of the subject matter may be embodied in practice.

In the drawings:

FIG. 1 schematically illustrates a side cross-sectional view of a mobile phone in security box according to an exemplary embodiment before mobile phone is being placed in it.

FIG. 2 illustrates the same mobile phone in security box of FIG. 1 above having mobile-phone placed inside it.

FIG. 3 schematically illustrates a block diagram of a mobile phone in security box according to an exemplary embodiment.

FIG. 4 schematically illustrates a block-diagram of a mobile phone in security box according to another exemplary embodiment that supports voice call while the user's mobile phone is within the mobile phone security box.

FIG. 5 schematically illustrates a block-diagram of a mobile phone in security box according to yet another exemplary embodiment that supports video and voice call while the user's mobile phone is within the mobile phone security box.

### DETAILED DESCRIPTION

Before explaining at least one embodiment in detail, it is to be understood that the subject matter is not necessarily limited in its application to the details set forth in the following description or exemplified by the examples. The subject matter is capable of other embodiments or of being practiced or carried out in various ways.

It will be appreciated that certain features, which are, for clarity, described in the context of separate embodiments, may also be provided in combination in a single embodiment. Conversely, various features of the subject matter, which are, for brevity, described in the context of a single embodiment, may also be provided separately or in any suitable sub-combination or as suitable in any other described embodiment. Certain features described in the context of various embodiments are not to be considered essential features of those embodiments, unless the embodiment is inoperative without those elements.

In discussion of the various figures described herein below, like numbers refer to like parts. The drawings are generally not to scale. For clarity, non-essential elements may have been omitted from some of the drawing.

To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, or the like) or multiple pieces of hardware. Similarly, the programs may be stand-alone programs, may be incorporated as subroutines in an operating system, may be functions in an installed software package, and the like.

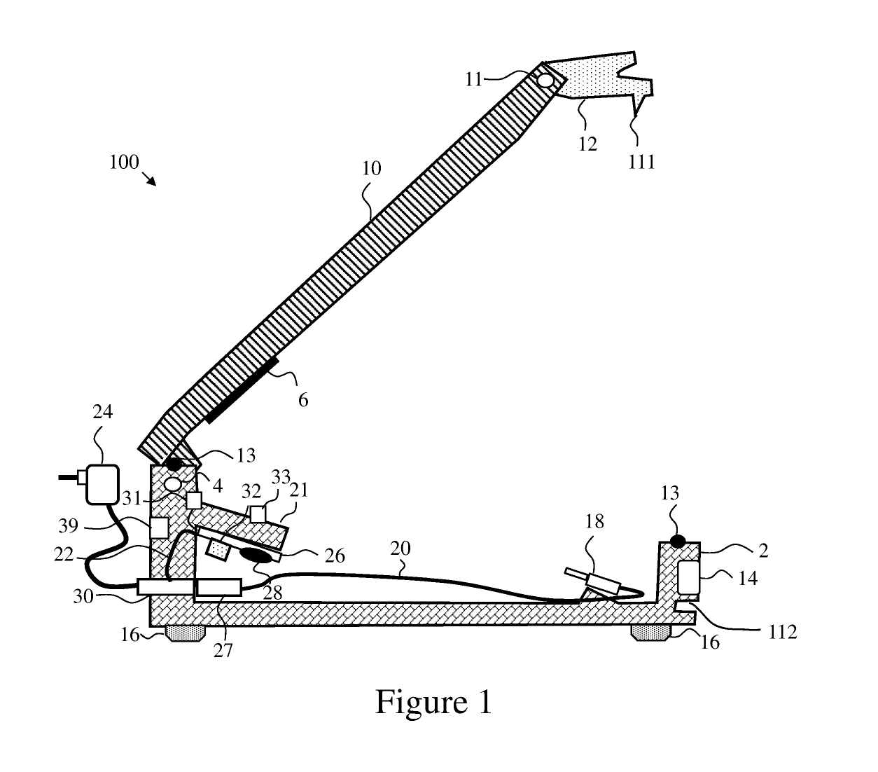

FIG. 1 schematically illustrates a side cross sectional view of a mobile phone in security box 100 according to an exemplary embodiment.

Mobile phone security box, also termed Active Quiet Box (AQB) apparatus 100 comprises of acoustically sealed chamber having bottom part 2 and top cover 10 coupled by one or more hinge/s 4. Optionally, the acoustically sealed chamber is made of plastic materials. One or more hinge/s 4 enables the top part 10 to open (rotate) upwards to allow easy mobile phone placement and removal by the user.

Top cover 10 is preferably made of transparent plastic material to allow users to view the mobile phone display once the phone is placed. The plastic material(s) used for at least one of parts 2 and 10 or both is designed and selected to have minimal attenuation of radio frequencies used by mobile phone operators and therefore it enables normal mobile phone reception and transmission while being placed in the chamber.

Four optional rubber bumper pads 16 attached to the bottom part 2 to optionally provide more friction to the surface underneath the device and to optionally provide further sound and vibration isolation.

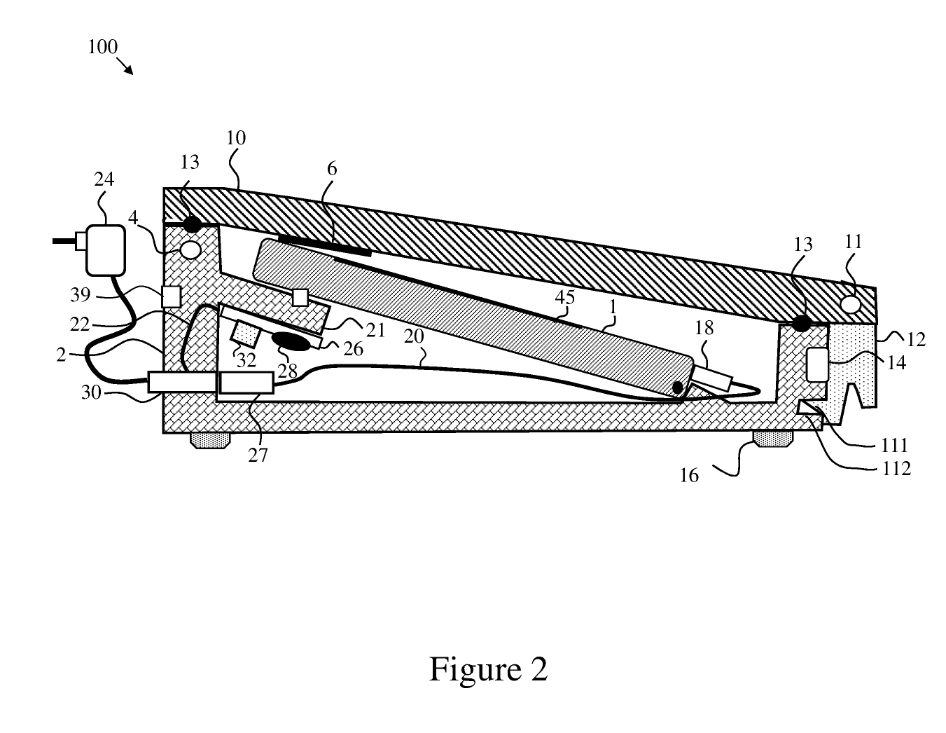

Rubber, foam or plastic seal 13, for example “O-Ring” seal 13 is located all around the bottom part 2 or top part 10 provides additional acoustic attenuation by sealing the internal chamber. Top cover 10 is further coupled by hinge 11 to front latch 12 having one or more locking tooth 111 to enable positive and secure enclosure sealing when interlocking in slot 112 as will be shown in next FIG. 2.

Internal flap 21 is made of similar plastic material and designed to support the mobile-phone when placed inside. Bottom part 2 is optionally designed to cover the mobile-phone rear camera that is facing down, or optionally provided with a mask for blocking the view of the mobile-phone rear camera.

Wall-mounted AC (Alternate Current) to DC (Direct Current) power supply 24 provides low voltage DC power to operate the apparatus. USB Type-A sealed jack 30 protrudes the plastic enclosure bottom part 2. USB jack 30 is sealed through rubber seal, sealant or adhesive material to prevent acoustic leakages. Preferably wall-mounted AC to DC power supply 24 may be disconnected and replaced by car adaptor (not shown here) to convert car voltage (12 or 24V) into lower voltage (for example 5V) needed to power the device.

Mobile phone charging cable 20 couples to the apparatus USB jack 30 through USB Type-A plug 27. The other end of the charging cable 20 is coupled to the mobile phone charging jack (shown in next FIG. 2) through phone specific charging plug 18. This plug 18 may be of various types or standards to match the specific mobile phone vendor and model. If charging cable 20 is long, excess cable may be folded and stored at the bottom of the chamber.

Electronic PCBA (Printed Circuit Board Assembly) 26 is fixed to the plastic chamber bottom part 2. Pressure sensor element 32 is placed on the PCBA 26 to enable sealing pressure sensing. Speaker 28 located on or near PCBA 28 is used to generate loud acoustical noise to block mobile phone acoustic reception.

LED indicator 14 is electrically coupled to the PCBA 26 through wires or light-pipes (not sown in this figure). LED indicator 14 is preferably red-green bi-color type to indicate apparatus state. When the chamber is open, red LED illuminates to indicate that the device is not secure. Optical, magnetic or electromechanical switch 31 used to sense the top cover 10 position and is electrically coupled to the PCBA 26. Wires 22 receive power from the USB jack 30 to supply the PCBA circuitry and coupled LED 14.

FIG. 2 illustrates the same mobile phone in security box 100 according to the exemplary embodiment shown in FIG. 1 above, while sealed with mobile phone 1 placed in it.

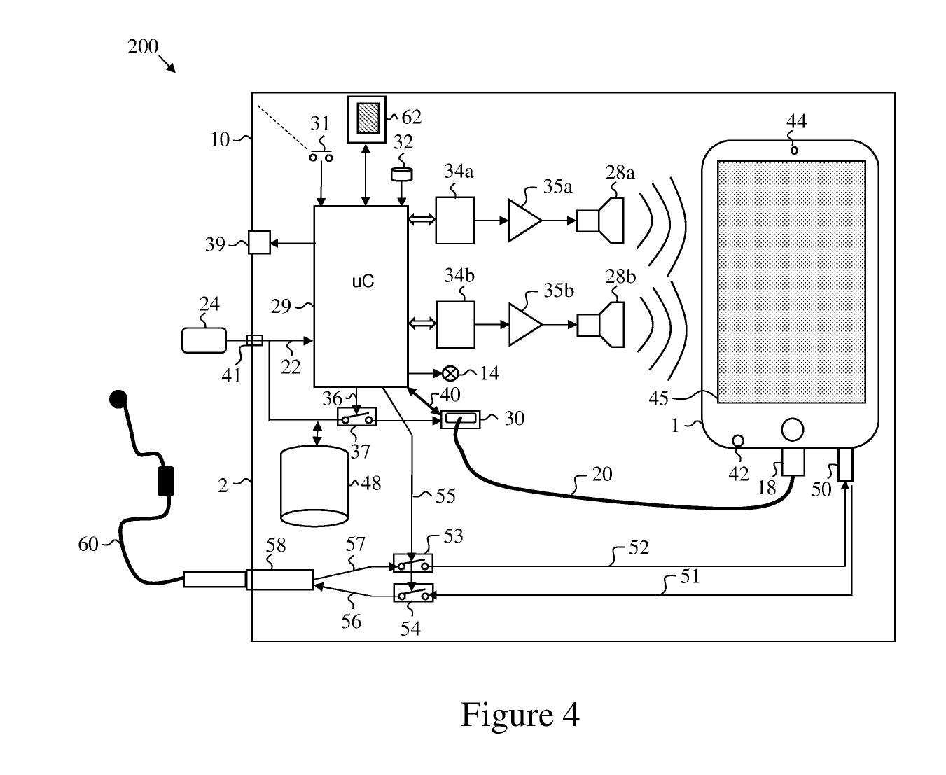

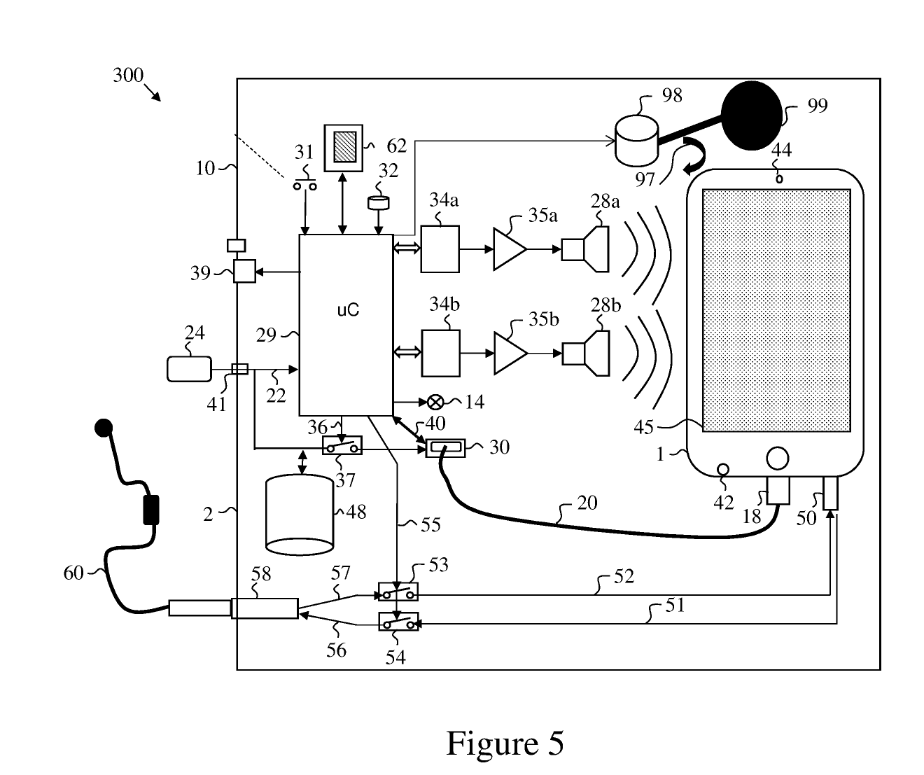

In this figure, the user placed his/her mobile phone 1 in the apparatus bottom part 2 with its display 45 facing upwards to enable visibility through the transparent top part 10 of visible indication appearing on display 45 such as incoming calls text or multimedia messages, as alert and messages. Opaque sticker 6 may be placed at the internal or external surface of the transparent top cover 10 to mask the field of view of the user's mobile phone front camera 44 (seen in FIGS. 4 and 5). Similarly, rear view camera may also be blocked by the flap 21, the enclosure bottom part, or by other means.

Power to charge the mobile phone 1 is delivered from the wall-mounted AC/DC power supply 24 through the USB Type-A jack 30, the charging cable USB plug 27, charging cable 20 and charging plug 18.

PCBA 26 is powered from the same AC/DC power supply 24. Once the Optical, magnetic or electromechanical switch 31 detects that the top cover 2 is closed and pressure sensor 32 senses pressure changes that indicate to the chamber sealing, the PCBA 26 generates loud noise or sound through one or more speakers 26i. As the chamber is sealed, the loud noise or sounds would not leave the sealed chamber at significant level that will annoy the user.

The air pressure sensor is an optional way to sense that the chamber is sealed. Air pressure increase is generated in the sealed box as the O-ring 13 is compressed when the cover is closed. If the O-Ring is damaged or missing or other mechanical problem occurs (for example—cracked cover, defective latch 12) then the pressure sensor would not sense the O-Ring compression. In an exemplary optional embodiment, pressure increase event is synchronized with the cover switch 31 to avoid false activation. When the cover is lowered and the air pressure increase is sensed, the sound generator and the green LED are activated. If one of the two sensors (cover switch and pressure sensor) is not activated, an alert, for example the red LED illumination may be activated.

One or more of speakers 26i may be electromagnetic, piezo-electric or any other sound transducer type.

Since the exact location of the microphone (or plurality of microphones) depends on the make and model of the phone, the locations of the microphone(s) is unknown. The box is small enough such that the sound level generated by speaker(s) 26 is sufficient all over the box in order to suppress any conversation or other sound entering the box from the outside of the box.

It should be noted that some phones may be equipped with multiple microphones and ambient noise suppression algorithms. Placing more than one speaker may optionally be used to create random phase shifted sound, thus preventing noise canceling DSP in the phone from locking on the sound location. It should be noted that post processing of recorded sound may be able to enhance and recover conversation or individual voice even when ambient sound level is high. Thus, the effectiveness of the acoustical masking has to be high in order to ensure that voice may not be recovered.

The acoustical isolation of the sealed chamber is advantageous as it attenuate the sound entering the chamber as well as exiting the chamber. Thus, high sound level may be used by the noise generator without annoying the user or other people near the AQB device. High sound level may saturate the microphone and/or the audio electronics within the mobile phone, causing distortions that hinders or prevents voice recovery. High sound level at frequencies outside the human hearing range may be used for the porous of saturate the microphone and/or the audio electronics within the mobile phone without annoying the user or other people near the AQB.

When the PCBA 26 detects proper chamber sealing, green LED 14 will illuminate. When the PCBA 26 detects that the chamber is not properly closed, or PCBA circuitry had failed red LED 14 will illuminate to warn the user that the mobile phone is unsafe. Preferably at such state, the charging cable 20 will be unpowered to force the user to fix the situation. If the user does not seal the chamber after pre-defined delay, the PCBA may generate aural warning through the one or more speakers 26i or dedicated speaker or buzzer 39 that is located or vented outside the chamber. Power to charge the phone at USB jack 27 may be optionally controlled by the PCBA 26 to assure that mobile phone 1 would not be charged unless the apparatus chamber is properly sealed.

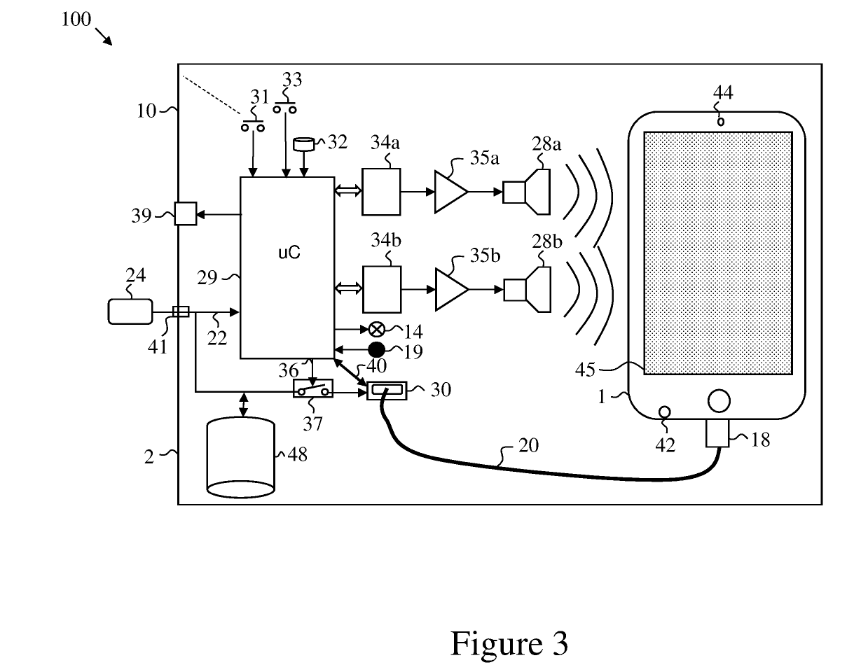

FIG. 3 schematically illustrates a block-diagram of a mobile phone in security box 100 according to an exemplary embodiment.

In FIG. 3, the construction of PCBA 26 shown in FIGS. 2 and 3 is further illustrated.

Wall-mounted AC/DC power supply 24 provides DC power to the apparatus through mini-USB jack 41. Wall-mounted AC/DC power supply 24 may be replaced by cigarette-lighter vehicle power adaptor (not shown here) to enable power from car DC power. Mini-USB jack 41 enable users to disconnect the wall-mounted power AC/DC power supply 24 and to connect DC/DC adapter such as vehicle cigarette-lighter adapter (not shown here) or a battery pack, for example such as phone charging battery pack.

Mini-USB jack 41 is coupled to the microcontroller 29 that monitors and controls the apparatus. Microcontroller function 29 controls the charging power switch 37 through output line 36 to enable charging power control by the microcontroller function 29. Power switch 37 may be relay or solid-state transistor based power switch. Power switch 37 couples the input DC power from mini-USB connector 41 to the USB Type-A charging jack 30 that is coupled through charging cable 20 and charging connector 8 to the mobile phone 1. Internal DC supply line 22 may be further connected to an optional non-rechargeable or rechargeable battery 48 to enable portable operation or to support vehicle operation when vehicle power is off. When the apparatus is powered from wall-mounted AC/DC power supply 24 and DC power not present due to power supply failure or AC power down, red LED 14 may illuminate audible warning may be sounded through speakers 26i or through the dedicated speaker or buzzer 39.

Top cover part 10 is optically, mechanically or magnetically coupled to the optical, magnetic or electromechanical switch 31 that is coupled electrically to the microcontroller 29 to provide top cover 10 closure indication.

Microcontroller 29 is further coupled to audio speaker(s) 28 (two such speakers, 28a and 28b are seen herein) through audio amplifiers 35a and 35b, audio CODECs 34x respectively. CODEC may generate random or semi-random white-noise, pink-noise, bubbles sound, human speech synthesis sounds, pre-recorded crowd sounds etc. Multiple CODECs 34x may generate similar sound at different variable phase to prevent mobile phone 1 one or more microphones 42 and their respective DSP (Digital Signal Processors) from locking on the noise source to filter it.

In these figures, the letter “x” when follows an element number (as in 34x herein, which may stands for 34a and 34b seen in FIG. 3) may stand for any letter such as {a, b, c . . . } or an absence of a letter to identify any one of a plurality of identical or similar elements, all having the same element numeral.

USB Type-A jack 30 data lines may be coupled through USB lines 40 to the microcontroller 29 to enable mobile phone 1 type detection and charger profile emulation.

Alternatively and optionally, the security box is equipped with other means to sense if a mobile phone was placed in it. For example, switch or a sensor 33 may be placed within the box, for example on optional flap 21, such that it is activated by the mobile phone 1. In an exemplary embodiment, while the security box is not connected to an external power, but is operated by the power of battery 48, the audio amplifier(s) 35x are activated only if sensor 33 indicates that mobile phone 1 is within the box to prevent power draining of battery 48 while the cover is closed.

Optionally, the security box is equipped with a sensor 19 for sensing a vibration of the phone which can be activated when receiving incoming call or a message or when issuing an alert such as alarm clock or a schedule appointment. Activation of sensor 19 may be used for flashing the LED 14 and/or sounding buzzer 39 to let the user know that he has a message.

In another embodiment, a multi-phone security box is provided for housing a plurality of mobile phones. The multi-phone security box may have separate chambers or bays, one for each phone. For example, such multi-phone security box may be placed on a meeting table such that every person in the meeting room is required to place his/her mobile phone in it during discussion of sensitive matters. Optionally, each of the chambers in a multi-chamber security box has its cover. Alternatively, one cover is used.

FIG. 4 schematically illustrates a block-diagram of a mobile phone in security box 200 according to yet another exemplary embodiment that supports voice call through connected wired headset or headphones 60.

Headset or headphones 60 having microphone element is coupled through the apparatus headset jack 58. Apparatus headset jack 38 is typically a 3.5 mm diameter jack that protrudes from the apparatus sealed chamber. It is therefore sealed to prevent acoustic leakages. Apparatus headset jack 38 microphone line 57 is coupled through the microphone isolation mux 53, switched microphone line 52 and headset plug 50 to the mobile-phone 1 headset jack. Similarly apparatus headset jack 38 headphone (audio output) line 56 is coupled through the headphone isolation mux 54 (two instances will be needed for stereo audio support), the switched headphone line 51 and headset plug 50 to the mobile-phone 1 headsets jack.

Illuminated push-button 62 coupled to the microcontroller function 29 allows the user to activate the headset audio through command line 55. This line switches the two mux (53 and 54) from mute (isolation) to on state. Mux 53 and 54 may be implemented through the use of components such as solid-state switch or electromechanical relay.

Controller function 29 commands the illuminated push-button 62 to illuminate in a specific color to indicate to the user that call is in progress. Preferably, during the call, the noise generator is disabled. After pre-programmed delay, the push-button 62 will start blinking. If the user presses the push-button 62, he/she may extend the call duration. Otherwise, the controller function 29 will command through line 55 the two mux 53 and 54 to switch back to isolation (off) state. Then controller function 29 will switch off the illuminated push-button 62.

This implementation prevents the sensitive headset microphone and headphone element from picking up background speech or voices when the user is not using the mobile phone 1 for call in progress.

FIG. 5 schematically illustrates a block-diagram of a mobile phone in security box 300 according to yet another exemplary embodiment that supports video and voice call while the user's mobile phone is within the mobile phone security box.

In this implementation, a movable opaque shutter 99 is normally placed in front of, and blocking the field of view of camera 44. Actuator such as solenoid or motor 98 can be activated by the user, for example by pressing push-button 62 to move 97 opaque shutter 99 such that the field of view of camera 44 is not interrupted. It should be noted that while the shatter 99 seen herein rotates in order to expose camera 44, linear or other motion of shutter may be used.

Optionally, separate push-button (not seen herein) is used for activating actuator 98. Optionally, same push-button 62 is used for activating actuator 98, for example by rapid succession of more than one pressing of push-button 62.

Optionally, controller function 29 commands the illuminated push-button 62 to illuminate in a different specific color to indicate to the user that video call is in progress. After pre-programmed delay, the push-button 62 will start blinking. If the user presses the push-button 62, he/she may extend the call duration. Otherwise, the controller function 29 will terminate the call and opaque shutter 99 will be again placed in front of, and blocking the field of view of camera 44. Then controller function 29 will switch off the illuminated push-button 62.

Optionally, the push-button(s) used for enabling voice and/or video call is monitored by a second timer such that if the a push-button is pressed for a prolog time, linger than the preset second timer, the AQB identifies the condition as an attempt to jam the push-button. In this case, the AQB returns to safe state and optionally issues an alert.

Alternatively, the push-button(s) used for enabling voice and/or video call is operated in a “push-to-activate”, such that only while pressing it the call is enabled.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, the embodiments are by no means limiting and are exemplary embodiments. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects.

Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

Although the subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art.

1. An Active Quiet Box (AQB) for a mobile phone comprising:
acoustically isolated and sealable chamber;
a support for supporting the mobile phone inside said acoustically isolated and sealable chamber; and
at least one noise generator to saturate the mobile-phone with loud ambient noise;
wherein the AQB is powered by a power source that is also configured to charge the mobile-phone.

2. The Active Quiet Box (AQB) of claim 1, wherein said acoustically isolated and sealable chamber further comprises at least one sensor configured to detect when the chamber is sealed.

3. The Active Quiet Box (AQB) of claim 2, wherein charging of the mobile phone is enabled when said at least one sensor is sensing that said sealable chamber is sealed.

4. The Active Quiet Box (AQB) of claim 2, wherein said at least one sensor to detect when the chamber is sealed is air pressure sensor.

5. The Active Quiet Box (AQB) of claim 1, wherein said acoustically isolated and sealable chamber is having transparent components so that the display of the mobile-phone can be seen when the chamber is sealed.

6. The Active Quiet Box (AQB) of claim 5, further comprising a non-transparent element positioned in a position that blocks field of view of a camera of the mobile-phone.

7. The Active Quiet Box (AQB) of claim 6, wherein said non-transparent element is a movable shutter, and wherein
said movable shutter is normally positioned in front of said camera,
and wherein said movable shutter is coupled to an actuator for moving said movable shutter so as to allow video call while the mobile-phone is within the AQB.

8. The Active Quiet Box (AQB) of claim 1, further comprising:
an audio connector for connecting a special wired headset to allow voice phone calls while the mobile-phone is within the AQB;
a switch normally isolating said audio connector from the mobile-phone and coupling said audio connector to the mobile-phone during voice phone calls;
a timer activating said switch to couple said audio connector to the mobile-phone for a preset time; and
a push button to activate said timer.

9. The Active Quiet Box (AQB) of claim 1, wherein said at least one noise generator is provided with at least two speakers to enable noise emission in random variable phase differences.

10. The Active Quiet Box (AQB) of claim 1, wherein said at least one noise generator is generating audio noise selected from a group of noises comprising white noise, pink noise, random speech, bubbles noise and crowd noise.

11. The Active Quiet Box (AQB) of claim 1, wherein said power source is a wall-mounted AC/DC power supply.

12. The Active Quiet Box (AQB) of claim 1, wherein said power source is a vehicle DC power adaptor.

13. The Active Quiet Box (AQB) of claim 1, further comprising an internal battery, Wherein said internal battery powers the AQB at times that external power source is unavailable.

14. The Active Quiet Box (AQB) of claim 1, further comprising user indicator to indicate secure and non-secure states.

15. The Active Quiet Box (AQB) of claim 13, further comprising user indicator to indicate secure and non-secure states,
wherein visual and aural indications are provided when the power source is a battery or when the battery is close to an empty state.

16. A method for securing a mobile-phone comprising:
placing the mobile-phone within an acoustically isolated and sealable chamber;
sealing said acoustically isolated and sealable chamber;
generating noise within said acoustically isolated and sealable chamber so as to saturate the mobile-phone with loud ambient noise; and
charging the mobile-phone within said sealable chamber

17. The method for securing a mobile-phone of claim 16, further comprising:
sensing that said acoustically isolated and sealable chamber is sealed; and
generating noise within said acoustically isolated and sealable chamber only while aid sealable chamber is sealed.

18. The method for securing a mobile-phone of claim 16, wherein charging the mobile-phone is enabled only when said acoustically isolated and sealable chamber is sealed.

19. The method for securing a mobile-phone of claim 17, wherein said sensing that said acoustically isolated and sealable chamber is sealed comprises sensing air pressure increase within said acoustically isolated and sealable chamber when said acoustically isolated and sealable chamber is being sealed.

20. The method for securing a mobile-phone of claim 16, further comprising indicating secure and non-secure states.
